(19) United States
(12) Patent Application Publication
(10) Pub. No.: US 2026/0279061 A1
(43) Pub. Date: Sep. 17, 2026

(54) WORK IDENTIFICATION DEVICE

(71) Applicant: TOYOTA JIDOSHA KABUSHIKI KAISHA, Toyota-shi (JP)

(72) Inventor: Natsuki Fujii, Nagakute-shi (JP)

(73) Assignee: TOYOTA JIDOSHA KABUSHIKI KAISHA, Toyota-shi (JP)

(21) Appl. No.: 19/432,580

(22) Filed: Dec. 24, 2025

(30) Foreign Application Priority Data
Mar. 17, 2025 (JP) 2025-042032

(51) Int. Cl. G06V 20/52; G06T 7/73; G06V 40/20

(52) U.S. Cl. CPC G06V 20/52; G06T 7/75; G06V 40/28; G06T 2207/20044; G06T 2207/30196

(57) ABSTRACT

A work identification device includes a coordinate acquisition unit, a skeleton model generation unit, a work identification unit, and a holding detection unit. When a detection is made that the worker holds the object by hand, the skeleton model generation unit generates the worker skeleton model by correcting the coordinates of the reference skeleton point according to a ratio of a reference height to a height of the worker for hand-related skeleton points among the plurality of skeleton points to obtain corrected reference coordinates, converting the coordinates of the hand-related skeleton points into relative coordinates with respect to the corrected reference coordinates, and converting the coordinates of other skeleton points excluding the hand-related skeleton points into relative coordinates with respect to the coordinates of the reference skeleton point.

### CROSS-REFERENCE TO RELATED APPLICATION

This application claims priority to Japanese Patent Application No. 2025-042032 filed on Mar. 17, 2025. The disclosure of the above-identified application, including the specification, drawings, and claims, is incorporated by reference herein in its entirety.

### BACKGROUND

### 1. Technical Field

The present disclosure relates to a work identification device.

### 2. Description of Related Art

In recent years, a system for identifying work performed by a worker using a captured image obtained by a camera or detection data obtained by a sensor mounted on a workwear has been proposed. In the system of Japanese Unexamined Patent Application Publication No. 2022-006708 (JP 2022-006708 A), a recognition model is generated by machine learning using a large amount of skeleton data consisting of coordinates of parts (hereinafter, referred to as "skeleton points") on a skeleton of the worker, such as a head, a joint, and a waist. Then, the skeleton data is acquired from the captured image obtained during the work, and the acquired skeleton data is applied to a machine learning model to identify the work.

### SUMMARY

There is a system that identifies work by comparing a skeleton model consisting of skeleton data obtained from a captured image with a reference skeleton model consisting of standard skeleton data. In this system, in order to suppress the influence of the difference in physique when generating the skeleton model, it is assumed that the skeleton model is generated by converting the coordinates of each skeleton point into relative coordinates with respect to a specific skeleton point. However, the present inventors have found that, when a worker executes work of holding an object, the relative coordinates of the skeleton points of the hand vary significantly for each worker due to the difference in physique, which causes a problem that a work identification accuracy is reduced.

(1) According to one aspect of the present disclosure, there is provided a work identification device for identifying work of a worker. The work identification device includes:

a coordinate acquisition unit configured to acquire a plurality of skeleton point coordinates, the skeleton point coordinates being coordinates of a predetermined plurality of skeleton points of a worker;

a skeleton model generation unit configured to generate a worker skeleton model that is a skeleton model of the worker by converting each of the skeleton point coordinates into relative coordinates with respect to coordinates of a reference skeleton point that is a predetermined skeleton point among the skeleton point coordinates;

a work identification unit configured to identify work of the worker by using the worker skeleton model and a reference skeleton model; and

a holding detection unit configured to detect that the worker holds an object by hand.

The skeleton model generation unit is configured to

obtain corrected reference coordinates by correcting the coordinates of the reference skeleton point according to a ratio of a reference height that is a height of a reference physique serving as a basis of the reference skeleton model to a height of the worker for hand-related skeleton points related to a hand of the worker among the skeleton points to, and

generate the worker skeleton model by converting coordinates of the hand-related skeleton points into relative coordinates with respect to the corrected reference coordinates, and converting coordinates of other skeleton points excluding the hand-related skeleton points into relative coordinates with respect to the coordinates of the reference skeleton point when a detection is made that the worker holds the object by hand.

According to the work identification device of this aspect, the worker skeleton model is generated by correcting the coordinates of the reference skeleton point according to the ratio of the reference height that is the height of the reference physique that is a basis of the reference skeleton model to the height of the worker for the hand-related skeleton points to obtain the corrected reference coordinates, converting the coordinates of the hand-related skeleton points into coordinates with respect to the corrected reference coordinates, and

converting the coordinates of the other skeleton points excluding the hand-related skeleton points into relative coordinates with respect to the coordinates of the reference skeleton point. Therefore, it is possible to suppress the relative coordinates of the skeleton points of the hand from deviating significantly from the coordinates of the skeleton points of the hand in the reference physique due to the difference in physique of the worker when the worker holds the object, and it is possible to suppress the work identification accuracy from being reduced.

(2) In the work identification device of the aspect, the coordinate acquisition unit may be configured to acquire the skeleton point coordinates by using detection results of a plurality of sensors provided at positions corresponding to the skeleton points in workwear worn by the worker.

According to the work identification device of this aspect, the coordinate acquisition unit is configured to acquire the plurality of skeleton point coordinates by using the detection results of the plurality of sensors provided at the positions corresponding to the plurality of skeleton points in the workwear worn by the worker. Therefore, the plurality of skeleton point coordinates can be accurately identified.

(3) In the work identification device of the aspect, the holding detection unit may be configured to detect that the worker holds the object by hand by using a captured image obtained by a first-person viewpoint camera worn by the worker.

According to the work identification device of this aspect, the holding detection unit is configured to detect that the worker holds the object by hand by using the captured image obtained by the first-person viewpoint camera worn by the worker. Therefore, it is possible to accurately detect that the worker holds the object by hand.

(4) In the work identification device of the aspect, the reference skeleton point may be a skeleton point provided on a chest of the worker.

According to the work identification device of this aspect, since the reference skeleton point is a skeleton point provided on the chest of the worker, it is possible to suppress the coordinates of the reference skeleton point from varying significantly for each type of work. Therefore, it is possible to make the relative coordinates of each skeleton point when executing the same type of work substantially the same as in a configuration in which the other skeleton points are the reference skeleton points. Therefore, it is possible to suppress the work identification accuracy from being reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a work identification system to which a work identification device as an embodiment of the present disclosure is applied;

FIG. 2 is a flowchart showing a procedure of work identification processing in the embodiment; and

FIG. 3 is a diagram showing an example of a skeleton model created in the work identification processing.

### DETAILED DESCRIPTION OF EMBODIMENTS

### A. Embodiment

### A1 System Configuration

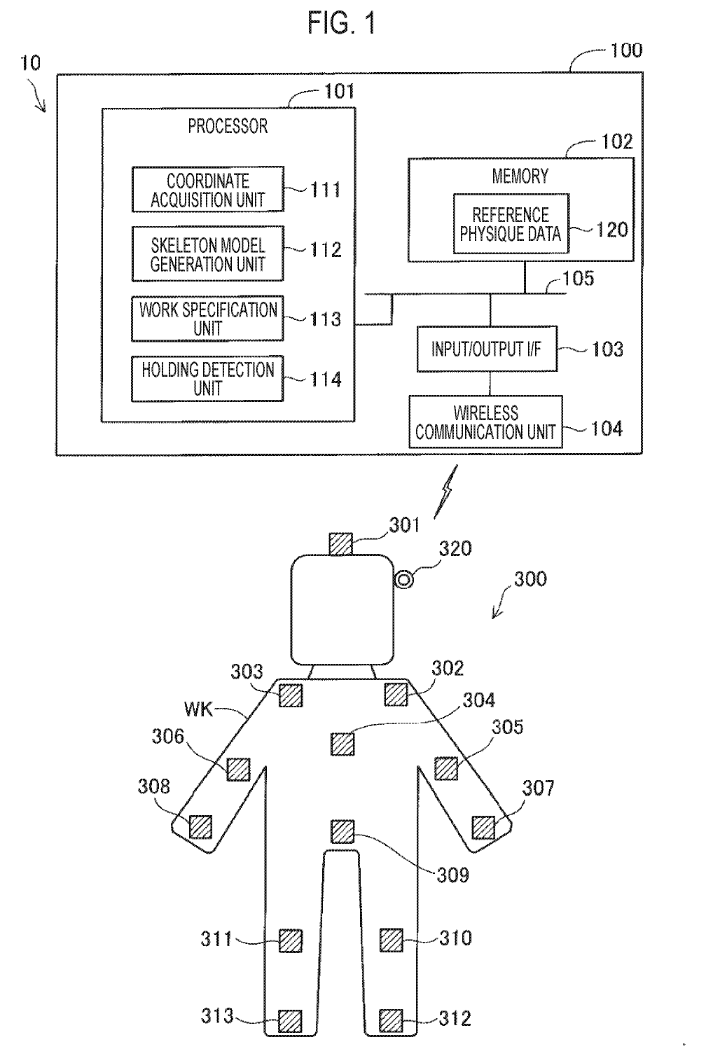

FIG. 1 is a block diagram showing a configuration of a work identification system 10 to which a work identification device 100 as an embodiment of the present disclosure is applied. The work identification system 10 is a system for identifying work of a worker WK. The term "identifying work" means identifying a work content or a work type. In the present embodiment, the worker WK is a person who is involved in a manufacturing process. The "work" identified by the work identification system 10 includes, for example, work on a manufactured product, such as tightening a screw, inserting a connector, holding an object with a hand, and carrying a member. Further, the "work" identified by the work identification system 10 includes work associated with the manufacturing process, such as a walking motion of the worker WK himself/herself in a case of moving for a next process. By identifying the work of the worker WK, for example, it is possible to evaluate the work executed by the worker WK by making a determination as to whether the work of the scheduled type is executed or whether the work of the scheduled amount is executed.

As shown in FIG. 1, the work identification system 10 includes a sensor 300 and the work identification device 100. The sensor 300 includes 13 mounted sensors 301 to 313 and one first-person viewpoint camera 320.

The 13 mounted sensors 301 to 313 are mounted on the worker WK and detect a motion of the worker WK. The 13 mounted sensors 301 to 313 are mounted in advance on a hat, workwear, or gloves worn by the worker WK. The 13 mounted sensors 301 to 313 include a sensor 301 disposed at a top of the head, a pair of sensors 302, 303 disposed at both shoulders, a chest sensor 304 disposed at a position of the chest, and a pair of sensors 305, 306 disposed at both arms. Further, the 13 mounted sensors 301 to 313 include a pair of wrist sensors 307, 308 disposed at both wrists, a sensor 309 disposed at a position of a waist, a pair of sensors 310, 311 disposed at both knees, and a pair of sensors 312, 313 disposed at both ankles. Each of the mounted sensors 301 to 313 includes a three-axis acceleration sensor, a three-axis gyro sensor, and the like, and detects a motion of each mounting part. In the present embodiment, the "motion" means a movement amount and a movement direction per predetermined time. The acceleration sensor and the gyro sensor are also referred to as an inertial measurement unit (IMU). Each of the mounted sensors 301 to 313 (IMU) outputs a detection result for each predetermined time. In the present embodiment, the "predetermined time" is 0.01 seconds. Each of the mounted sensors 301 to 313 includes a wireless communication unit (not shown) and outputs the detection result to the outside by wireless communication. The "wireless communication" corresponds to, for example, wireless LAN defined by IEEE 802.11 or the like, Bluetooth (registered trademark), infrared communication, and the like. Data detected by each of the mounted sensors 301 to 313 is referred to as "sensor data".

The first-person viewpoint camera 320 is a camera called a so-called first-person view (FPV) and images the surroundings (front) of the worker WK from a viewpoint substantially the same as the viewpoint of the worker WK. The first-person viewpoint camera 320 acquires, for example, 100 frame images per second. In the present embodiment, the first-person viewpoint camera 320 is disposed at the head of the worker WK.

In the present embodiment, the work identification device 100 is configured by a computer. The work identification device 100 includes a processor 101, a memory 102, an input/output interface unit 103, and a wireless communication unit 104. The input/output interface unit 103 consists of an interface group for realizing input and output to the work identification device 100. The wireless communication unit 104 is connected to the input/output interface unit 103. The wireless communication unit 104 performs the wireless communication with the mounted sensors 301 to 313 and the first-person viewpoint camera 320. The processor 101, the memory 102, and the input/output interface unit 103 are configured to exchange data with each other via an internal bus 105. The memory 102 includes a random access memory (RAM) in addition to a non-volatile memory such as an electrically erasable programmable read-only memory (EEPROM). In addition to a control program (not shown), the memory 102 stores reference physique data 120 in advance.

The reference physique data 120 is data indicating a standard physique (hereinafter, referred to as a "reference physique") of a person who performs the same work as the work performed by the worker WK, and is prepared in advance for each type of work. Specifically, the reference physique data 120 is coordinate data of skeleton points of a person having a reference physique, which is prepared for each type of work. The "skeleton point" is a point of a predetermined part of a body (skeleton) of the worker (including the worker WK). The skeleton point is predetermined as a point of a part of the body of the worker that can identify a motion or a posture of the body. In the present embodiment, the point of the part where each of the mounted sensors 301 to 313 is disposed corresponds to the skeleton point. The "coordinate data" means data indicating relative coordinates of other skeleton points with coordinates of a predetermined reference skeleton point as a reference (origin). In the present embodiment, the "reference skeleton point" is a skeleton point provided on the chest. The chest is a part whose position does not change significantly even when the worker performs various types of work. Therefore, it is possible to make the relative coordinates of each skeleton point when executing the same type of work substantially the same. A set of relative coordinate data of each skeleton point indicated by the reference physique data 120 is a skeleton model of a person having a "standard physique", and is referred to as a "reference skeleton model" in the present embodiment.

The processor 101 executes the control program stored in the memory 102 to function as a coordinate acquisition unit 111, a skeleton model generation unit 112, a work identification unit 113, and a holding detection unit 114.

The coordinate acquisition unit 111 acquires coordinates (hereinafter, referred to as "skeleton point coordinates") of each skeleton point of the worker WK. Specifically, the coordinates of each skeleton point are identified and acquired based on the detection results of each of the mounted sensors 301 to 313. In the present embodiment, the "coordinates" include coordinates of an X axis and a Y axis parallel to a horizontal direction and coordinates of a Z axis parallel to a vertical direction. It should be noted that, in the horizontal direction, only the coordinate of one axis may be used.

The skeleton model generation unit 112 generates a skeleton model (hereinafter, referred to as a "worker skeleton model") of the worker WK. The worker skeleton model is a set of data of relative coordinates of each skeleton point of the worker WK with respect to the skeleton point provided on the chest of the worker WK, similarly to the reference skeleton model indicated by the reference physique data 120.

The work identification unit 113 identifies the work of the worker WK by using the worker skeleton model and the reference skeleton model. A specific identification method will be described below.

The holding detection unit 114 detects that the worker WK holds the object with the hand. Specifically, the holding detection unit 114 detects that the worker WK holds the object with the hand by using the captured image obtained by the first-person viewpoint camera 320. In this case, for example, a template image of the hand holding the object may be stored in advance in the memory 102, and the object holding may be detected by pattern matching of comparing the template image and the captured image. In addition, for example, the captured image of the first-person viewpoint camera 320 may be input to a detection model using artificial intelligence to perform the detection. Such a detection model is prepared, for example, in the work identification system 10 or outside the work identification system 10, and is stored in advance in the memory 102 of the work identification system 10. Examples of the detection model include a trained machine learning model that has been trained to implement any of semantic segmentation and instance segmentation. As the machine learning model, for example, a convolutional neural network (CNN) that has been trained by supervised learning using a training data set can be used. The training data set includes, for example, a plurality of training images including a hand and an object held by the hand, and a label indicating whether each region in the training image is a region indicating the hand of the worker WK or a region indicating the object held by the hand.

### A2 Work Identification Processing

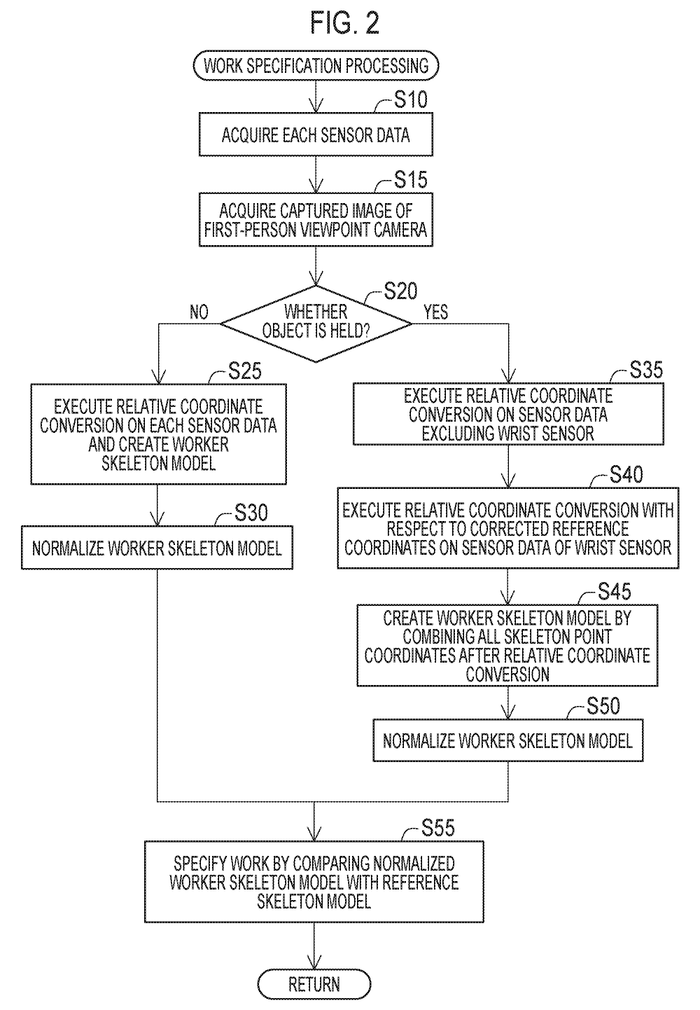

FIG. 2 is a flowchart showing a procedure of the work identification processing in the embodiment. The work identification processing is processing of identifying the work performed by the worker WK. The work identification processing is executed when the power of the work identification device 100 is turned on.

In S10, a coordinate acquisition unit 111 acquires the sensor data of each of the mounted sensors 301 to 313.

In S15, a skeleton model generation unit 112 acquires the captured image of the first-person viewpoint camera 320. In S20, the holding detection unit 114 determines whether the object is held by the worker WK by using the captured image obtained in S15.

When the determination is made that the object is not held by the worker WK (S20: NO), in S25, the skeleton model generation unit 112 executes the relative coordinate conversion on the sensor data of each of the mounted sensors 301 to 313 to generate the worker skeleton model of the worker WK. Specifically, the skeleton model generation unit 112 identifies the coordinates of each skeleton point from each sensor data. Thereafter, the coordinates of each skeleton point are converted into relative coordinates with the coordinates of the reference skeleton point, that is, the coordinates of the skeleton point provided on the chest identified from the sensor data of the chest sensor 304 as the origin to generate the worker skeleton model.

In S30, the skeleton model generation unit 112 normalizes the worker skeleton model created in S25. Specifically, the coordinates of each skeleton point of the skeleton model obtained in S25 are adjusted according to a ratio (hereinafter, referred to as a "height ratio") of a height of a person having a reference physique that is a basis of the reference skeleton model to a height of the worker WK. The height of the worker WK can be obtained by using the coordinates of each skeleton point before the normalization. Specifically, the skeleton model generation unit 112 obtains a "distance from the top of the head to the shoulder", a "distance from the shoulder to the waist", a "distance from the waist to the knee", and a "distance from the knee to the ankle" by using the coordinates of each skeleton point. Then, the total distance obtained by adding these distances is obtained as the height. The height of the person having the reference physique can be obtained from the reference physique data 120. It should be noted that the height of the person having the reference physique may be stored in advance in the memory 102, and the height of the worker WK may be obtained in advance by using the sensor data of each of the mounted sensors 301 to 313 and stored in the memory 102. Further, the "height ratio" may be calculated in advance by using the stored height and stored in the memory 102.

In S55, the holding detection unit 114 identifies the work of the worker WK by comparing the normalized worker skeleton model with each reference skeleton model. In the present embodiment, the deviation of the coordinates of the same skeleton point between the normalized worker skeleton model and the reference skeleton model is added for each work. Then, the work corresponding to the reference skeleton model having the smallest obtained deviation total value is identified as the work of the worker WK. It should be noted that the deviation total value may be obtained by weighting the deviation of the coordinates of the skeleton point indicating the characteristic posture in each work. In this way, the work can be identified with higher accuracy.

In S20, when the determination is made that the object is held by the worker WK (S20: YES), the processing proceeds to S35. In S35, the skeleton model generation unit 112 executes the relative coordinate conversion on the sensor data of the other mounted sensors 301 to 306, 309 to 313 excluding the wrist sensors 307, 308. The processing content of S35 is the same as the processing content of S25 described above.

In S40, the skeleton model generation unit 112 executes the relative coordinate conversion with respect to the corrected reference coordinates on the sensor data of the wrist sensors 307, 308. The "corrected reference coordinates" mean coordinates in which only the Z-axis coordinate (coordinate in the height direction) of the skeleton point coordinates (X, Y, Z-axis coordinates) of the chest in the reference skeleton model is corrected. Specifically, coordinates obtained by multiplying the height ratio by the Z-axis coordinate are used as the Z-axis coordinates of the corrected reference coordinates.

In S45, the skeleton model generation unit 112 creates the worker skeleton model by combining all the skeleton point coordinates after the relative coordinate conversion in S35 and S40.

In S50, the skeleton model generation unit 112 normalizes the worker skeleton model created in S50. The processing content of S50 is the same as the processing content of S30 described above. After the completion of S50, S55 is executed, and the work of the worker WK is identified. After the completion of S55, the processing returns to S10.

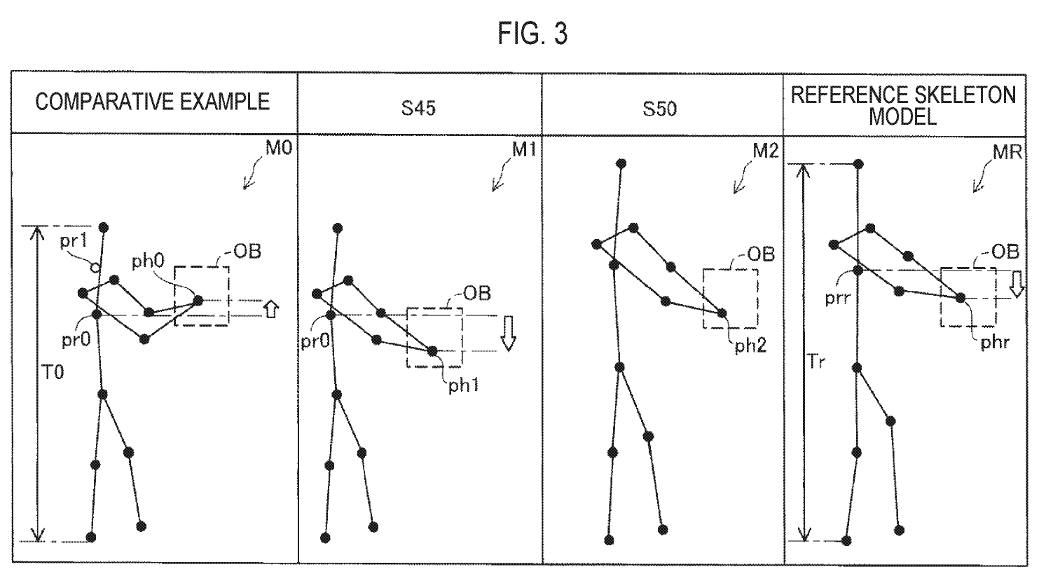

FIG. 3 is a diagram showing an example of a skeleton model created in the work identification processing. In FIG. 3, the leftmost one shows a skeleton model M0 in the comparative example. In FIG. 3, the second from the left shows a worker skeleton model M1 generated in S45. In FIG. 3, the third from the left shows a skeleton model M2 generated in S50. In FIG. 3, the rightmost one shows a reference skeleton model MR. It should be noted that the three skeleton models M0 to M2 on the left side all show the skeleton model when the worker WK is the same person. In addition, all of the skeleton models M0 to M2, MR show the skeleton model that is executing the work of "placing the object OB on a workbench at a predetermined height while holding the object OB with the hand". The skeleton model M0 of the comparative example is created by executing the relative coordinate conversion with the skeleton point pr0 of the chest as the reference skeleton point on the sensor data of all the mounted sensors 301 to 313, despite the fact that the object OB is being held.

As can be seen by comparing the skeleton models M0, M1 with the reference skeleton model MR, the height T0 of the worker WK is significantly lower than the height Tr of the person having the reference physique. Therefore, in the skeleton model M0 of the comparative example, the coordinates of the wrist skeleton point ph0 are positioned above the coordinates of the chest skeleton point pr0 that is the reference skeleton point. On the other hand, in the reference skeleton model MR, the coordinates of the wrist skeleton point phr are positioned below the coordinates of the chest skeleton point prr that is the reference skeleton point. Therefore, when the skeleton model obtained by normalizing the skeleton model M0 is compared with the reference skeleton model MR, the deviation of both arms and the deviation of the wrists are large. As a result, there is a concern that the work of the worker WK is identified as work different from the work of "placing the object OB on a workbench at the same height while holding the object OB with the hand". It should be noted that, in FIG. 3, the corrected reference coordinates pr1 are additionally shown for the skeleton model M0 of the comparative example. This will be described below.

On the other hand, in the present embodiment, the coordinates of the wrist skeleton point ph1 are subjected to the relative coordinate conversion with the corrected reference coordinates pr1 as the origin, instead of the coordinates of the skeleton point pr0 that is the reference skeleton point of the skeleton model M0. Therefore, as shown in the worker skeleton model M1, the coordinates of the skeleton point ph1 are positioned below the coordinates of the chest skeleton point pr0 that is the reference skeleton point. Therefore, the skeleton model M2 after the normalization in S50 is similar to the reference skeleton model MR. That is, the deviation between the coordinates of the wrist skeleton point ph2 in the skeleton model M2 and the coordinates of the wrist skeleton point phr in the reference skeleton model MR is reduced. Therefore, according to the present embodiment, the work of the worker WK can be accurately identified as the work of "placing the object OB on a workbench at the same height while holding the object OB with the hand".

According to the work identification device 100 of the embodiment described above, the coordinates of the reference skeleton point are corrected according to the ratio of the reference height that is the height of the reference physique that is a basis of the reference skeleton model to the height of the worker to obtain the corrected reference coordinates. The coordinates of the wrist skeleton point are converted into relative coordinates with respect to the corrected reference coordinates. The coordinates of the other skeleton points excluding the wrist skeleton point are converted into relative coordinates with respect to the coordinates of the reference skeleton point. In this way, since the worker skeleton model is generated for the wrist skeleton point, it is possible to suppress the relative coordinates of the wrist skeleton point from deviating significantly from the coordinates of the skeleton point of the hand in the reference physique due to the difference in physique of the worker when the worker holds the object. Therefore, it is possible to suppress the work identification accuracy from being reduced.

In addition, the coordinate acquisition unit 111 acquires a plurality of skeleton point coordinates by using the detection results of a plurality of mounted sensors 301 to 313 provided at the positions corresponding to a plurality of skeleton points in the workwear worn by the worker WK. As a result, the skeleton point coordinates can be accurately identified.

In addition, the holding detection unit 114 detects that the worker WK holds the object OB with the hand by using the captured image obtained by the first-person viewpoint camera 320 worn by the worker WK. As a result, it is possible to accurately detect that the worker WK holds the object OB with the hand.

In addition, since the reference skeleton point is a skeleton point provided on the chest of the worker WK, it is possible to suppress the coordinates of the reference skeleton point from varying significantly for each type of work. Therefore, it is possible to make the relative coordinates of each skeleton point when executing the same type of work substantially the same as in a configuration in which the other skeleton points are the reference skeleton points. Therefore, it is possible to suppress the work identification accuracy from being reduced.

### B. Other Embodiments

### B1

In the above-described embodiment, in S40, the sensor data that is the target of the relative coordinate conversion with respect to the corrected reference coordinates is the sensor data of the wrist sensors 307, 308, but the present disclosure is not limited to this. The sensor data of the sensors 305, 306 disposed at both arms may be the target instead of or in addition to the sensor data of the wrist sensors 307, 308. In addition, a sensor may be provided on a back of the hand or a finger of the hand, and the sensor data output from the sensor may be the target. The present inventors have found that the relative coordinates of skeleton points related to the hands (hereinafter, referred to as "hand-related skeleton points") can vary significantly depending on the height of the worker WK when the work of holding the object OB is performed. Therefore, by making such sensor data of the hand-related skeleton points the target of the relative coordinate conversion with respect to the corrected reference coordinates, the same effect as in the above-described embodiment can be achieved.

### B2

In the above-described embodiment, the coordinate acquisition unit 111 identifies and acquires the coordinates of each skeleton point based on the detection results of each of the mounted sensors 301 to 313, but the present disclosure is not limited to this. For example, the coordinates of each skeleton point may be acquired by using pattern matching or a machine learning model based on the captured image obtained by a camera that is not mounted on the worker WK, for example, a camera that is fixedly installed at a work location.

### B3

In the above-described embodiment, the holding detection unit 114 detects that the worker WK holds the object with the hand by using the captured image obtained by the first-person viewpoint camera 320, but the present disclosure is not limited to this. For example, it may be detected that the worker WK holds the object with the hand by using pattern matching or a machine learning model based on the captured image obtained by a camera that is not mounted on the worker WK, for example, a camera that is fixedly installed at a work location.

### B4

In the above-described embodiment, the reference skeleton point is the skeleton point provided on the chest of the worker WK, but the present disclosure is not limited to this. For example, the reference skeleton point may be a skeleton point provided on a waist. By setting the skeleton point of which the position change is small according to the type of work as the reference skeleton point, the relative coordinates of each skeleton point when executing the same type of work can be made substantially the same. Therefore, it is possible to suppress the work identification accuracy from being reduced.

### B5

The present disclosure is not limited to the work identification device 100 described above, and can be implemented in various aspects. For example, the work identification system 10 or the work identification method can be implemented. In addition, these devices or methods can be implemented by a computer program for implementing these devices or methods, a non-transitory tangible recording medium on which such a computer program is recorded in a readable manner by a computer, and the like.

The present disclosure is not limited to the above-described embodiments, and can be implemented with various configurations without departing from the gist of the present disclosure. For example, the technical features of the embodiments corresponding to the technical features in each form described in the section of SUMMARY can be replaced or combined as appropriate to solve some or all of the above objects, or to achieve some of or all the above effects. In a case where the technical features are not described as being always needed in the present specification, the features can be deleted as appropriate.

What is claimed is:

1. A work identification device comprising:
a coordinate acquisition unit configured to acquire a plurality of skeleton point coordinates, the skeleton point coordinates being coordinates of a predetermined plurality of skeleton points of a worker;
a skeleton model generation unit configured to generate a worker skeleton model that is a skeleton model of the worker by converting each of the skeleton point coordinates into relative coordinates with respect to coordinates of a reference skeleton point that is a predetermined skeleton point among the skeleton point coordinates;
a work identification unit configured to identify work of the worker by using the worker skeleton model and a reference skeleton model; and
a holding detection unit configured to detect that the worker holds an object by hand,
wherein the skeleton model generation unit is configured to
obtain corrected reference coordinates by correcting the coordinates of the reference skeleton point according to a ratio of a reference height that is a height of a reference physique serving as a basis of the reference skeleton model to a height of the worker for hand-related skeleton points related to a hand of the worker among the skeleton points to, and
generate the worker skeleton model by converting coordinates of the hand-related skeleton points into relative coordinates with respect to the corrected reference coordinates, and converting coordinates of other skeleton points excluding the hand-related skeleton points into relative coordinates with respect to the coordinates of the reference skeleton point
when a detection is made that the worker holds the object by hand.

2. The work identification device according to claim 1, wherein the coordinate acquisition unit is configured to acquire the skeleton point coordinates by using detection results of a plurality of sensors provided at positions corresponding to the skeleton points in workwear worn by the worker.

3. The work identification device according to claim 1, wherein the holding detection unit is configured to detect that the worker holds the object by hand by using a captured image obtained by a first-person viewpoint camera worn by the worker.

4. The work identification device according to claim 1, wherein the reference skeleton point is a skeleton point provided on a chest of the worker.
